(19) United States
(12) Patent Application Publication
(10) Pub. No.: US 2025/0078155 A1
(43) Pub. Date: Mar. 6, 2025

(54) METHOD FOR PARALLEL COUNTERPARTY RISK CALCULATION

(71) Applicant: FMR LLC, Boston, MA (US)

(72) Inventor: Yechao Zhu, Dorchester, MA (US)

(21) Appl. No.: 18/241,162

(22) Filed: Aug. 31, 2023

(51) Int. Cl. G06Q 40/06

(52) U.S. Cl. CPC G06Q 40/06

(57) ABSTRACT

A method for calculating counterparty risk using a risk calculation application includes receiving a plurality of transactions in a portfolio, each including a market value and a beta value. The method includes generating, in parallel, a plurality of market scenarios based on a log-normal distribution. The method also includes calculating, in parallel, an average market scenario and a high-risk market scenario based on the plurality of market scenarios. The method further includes calculating, in parallel, a beta-adjusted portfolio value based on the plurality of market values and the plurality of beta values. The method includes calculating, an expected portfolio exposure based on the beta-adjusted portfolio value and the average market scenario. The method also includes calculating a potential portfolio exposure based on the beta-adjusted portfolio value and the high-risk market scenario. The method includes storing the expected portfolio exposure and the potential portfolio exposure in a database.

### BACKGROUND

### Technical Field

The present invention relates to counterparty risk in financial transactions, and more specifically to calculating counterparty risk in parallel.

### Background

Counterparty risk is the risk associated with the other party to a financial contract not meeting its obligations. Every derivative trade has a party on the opposite side. For example, credit default swaps, a common derivative with counterparty risk, are often traded directly with another party, as opposed to trading on a centralized exchange. Since the contract is directly connected with the other party, there is a greater risk of counterparty default before the contract is fulfilled since both parties may not have full knowledge of the financial health of the other (and their ability to cover obligations). This differs from products listed on an exchange where the exchange is the counterparty, not the single entity on the other side of the trade.

Counterparty risk calculation for a portfolio or fund is typically performed using a certain number of market simulations, such as 10,000, and takes 6-8 hours for a portfolio. A higher number of market simulations would be advantageous, but, given the sequential nature of the current process, would be very time-consuming.

### SUMMARY

In accordance with an embodiment of the present invention, the deficiencies of the prior art are overcome by providing a method for calculating counterparty risk in parallel using a risk calculation application executing on a computer system. The method includes receiving, by the risk calculation application, a plurality of transactions in a portfolio, each one of the transactions including a market value and a beta value. The method includes generating, by the risk calculation application and in parallel, a plurality of market scenarios based on a log-normal distribution. The method also includes calculating, by the risk calculation application and in parallel, an average market scenario and a high-risk market scenario based on the plurality of market scenarios. The method further includes calculating, by the risk calculation application and in parallel, a beta-adjusted portfolio value based on the plurality of market values and the plurality of beta values. The method includes calculating, by the risk calculation application, an expected portfolio exposure based on the beta-adjusted portfolio value and the average market scenario. The method also includes calculating, by the risk calculation application, a potential portfolio exposure based on the beta-adjusted portfolio value and the high-risk market scenario. The method includes storing, by the risk calculation application, the expected portfolio exposure and the potential portfolio exposure in a database.

Alternatively, or in addition, the risk calculation application is portable between a plurality of computer system architectures. The plurality of computer system architectures may include a central processing unit-based architecture, a graphical processing unit-based architecture, and a tensor processing unit-based architecture.

Also alternatively, or in addition, the plurality of market scenarios is generated using an output of a random number generator to determine samples from the log-normal distribution. The random number generator may be initialized with a random seed. The method may further include storing, by the risk calculation application, the random seed in the database.

Alternatively, or in addition, the method may further include filtering, by the risk calculation application and in parallel, the plurality of market scenarios to only include positive market scenarios. The plurality of market scenarios may include at least 10,000,000 market scenarios. The risk calculation application may generate the plurality of market scenarios and performs all calculations in a memory of the computer system.

In accordance with another embodiment of the present invention, a system for calculating counterparty risk includes a computer system having a processor coupled to a memory. The processor is configured to execute a risk calculation application. The risk calculation application is configured to receive a plurality of transactions in a portfolio, each one of the transactions including a market value and a beta value. The risk calculation application is configured to generate, in parallel, a plurality of market scenarios based on a log-normal distribution. The risk calculation application is configured to calculate, in parallel, an average market scenario and a high-risk market scenario based on the plurality of market scenarios. The risk calculation application is configured to calculate, in parallel, a beta-adjusted portfolio value based on the plurality of market values and the plurality of beta values. The risk calculation application is configured to calculate an expected portfolio exposure based on the beta-adjusted portfolio value and the average market scenario. The risk calculation application is also configured to calculate a potential portfolio exposure based on the beta-adjusted portfolio value and the high-risk market scenario. The risk calculation application is further configured to store the expected portfolio exposure and the potential portfolio exposure in a database.

Alternatively, or in addition, the risk calculation application is portable between a plurality of computer system architectures. The plurality of computer system architectures may include a central processing unit-based architecture, a graphical processing unit-based architecture, and a tensor processing unit-based architecture.

Also alternatively, or in addition, the plurality of market scenarios is generated using an output of a random number generator to determine samples from the log-normal distribution. The random number generator may be initialized with a random seed. The risk calculation application may further be configured to store the random seed in the database.

Alternatively, or in addition, the risk calculation application is further configured to filter, in parallel, the plurality of market scenarios to only include positive market scenarios. The plurality of market scenarios may include at least 10,000,000 market scenarios. The risk calculation application may generate the plurality of market scenarios and performs all calculations in a memory of the computer system.

In accordance with yet another embodiment of the present invention, a non-transitory computer-readable medium has software encoded thereon. The software, when executed by one or more processors, is operable to receive a plurality of transactions in a portfolio, each one of the transactions including a market value and a beta value. The software is operable to generate, in parallel, a plurality of market scenarios based on a log-normal distribution. The software is operable to calculate, in parallel, an average market scenario and a high-risk market scenario based on the plurality of market scenarios. The software is operable to calculate, in parallel, a beta-adjusted portfolio value based on the plurality of market values and the plurality of beta values. The software is operable to calculate an expected portfolio exposure based on the beta-adjusted portfolio value and the average market scenario. The software is operable to calculate a potential portfolio exposure based on the beta-adjusted portfolio value and the high-risk market scenario. The software is operable to store the expected portfolio exposure and the potential portfolio exposure in a database.

### BRIEF DESCRIPTION OF THE DRAWINGS

The description below refers to the accompanying drawings, of which:

FIG. 1 is an illustration of a system for calculating counterparty risk in accordance with an embodiment of the present invention;

FIG. 2 is a flowchart of a method for calculating counterparty risk in accordance with an embodiment of the present invention; and

FIG. 3 is a memory chart for a method for calculating counterparty risk in accordance with an embodiment of the present invention.

### DETAILED DESCRIPTION OF ILLUSTRATIVE EMBODIMENTS

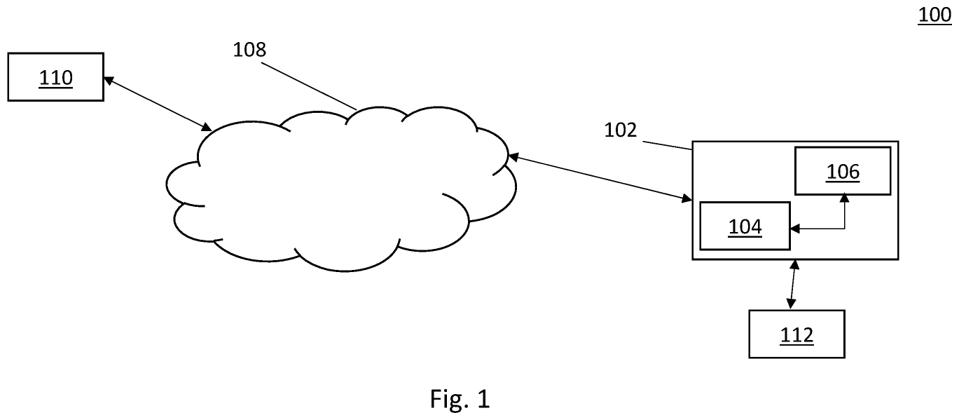

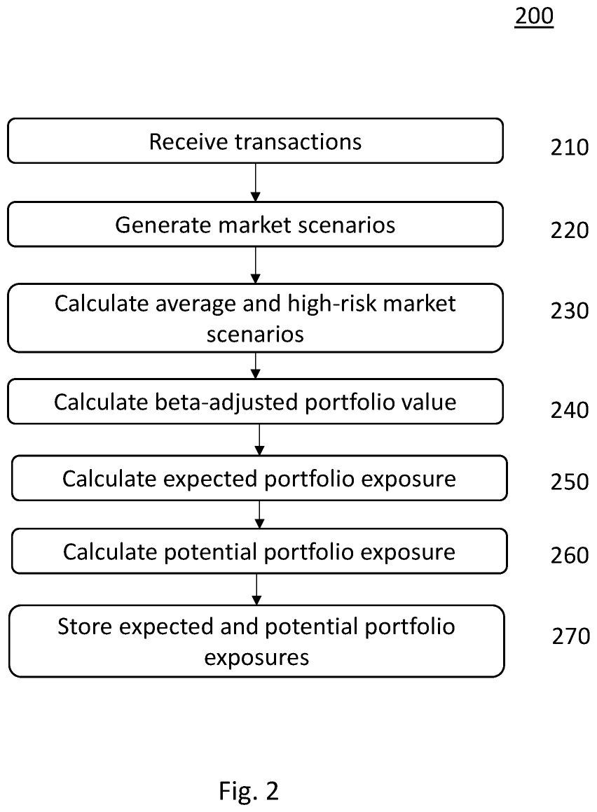

FIG. 1 is an illustration of a system 100 for calculating counterparty risk in accordance with an embodiment of the present invention. System 100 includes a computer system 102. The computer system 102 has a processor 104 coupled to a memory 106. The computer system 102 may also be communicatively coupled to a communications network 108. Network 108 may be a public network, such as the internet, or it may be a private network, such as a network internal to a company. Network 108 also may be a combination of public and/or private networks. The computer system 102 may be coupled to the network 108 directly, for example via an Ethernet cable or via wireless connection such as Wi-Fi. Computer system 102 may also be coupled to the network 108 in any other way known to the skilled person, for example indirectly through another device (not shown), such, as, but not limited to, a router, a switch, a hub, a separate computer system, a mobile device, a modem, and/or a combination of these devices. The processor 104 is configured to execute a risk calculation application that is configured to execute the method described below in detail with reference to FIG. 2. Advantageously, the processor 104 allows for parallel processing, for example by providing a plurality of cores. While a processor 104 is described herein, it is expressly contemplated that the computer system 102 has a plurality of processors. In that case, each of the plurality of processors of computer system 102 is coupled to the memory 106 and is configured to execute the risk calculation application described below. The plurality of processors allows for parallel processing. In addition, one or more of the plurality of processors may provide a plurality of cores to further enhance the parallel processing capabilities of computer system 102. Also part of system 100 may be an optional graphics processing unit (GPU), tensor processing unit (TPU), and/or Neural Processing Unit (NPU) 112. The GPU/TPU/NPU 112 may be communicatively coupled to computer system 102, or it may be a part of computer system 102. In other embodiments, the GPU/TPU/NPU 112 may be a cloud-based GPU/TPU/NPU coupled to the network 108 and may be accessed by the computer system 102 over the network 108. The GPU/TPU/NPU 112 may also include its own memory. While the optional GPU/TPU/NPU 112 is shown in FIG. 1, it is expressly contemplated that system 100 does not include a GPU, TPU, or NPU.

Further coupled to the network 108 may be a database 110. The database 110 may be provided by any publicly available database system known to the skilled person. It may be a commercial database or an open-source database. While the database 110 is show here coupled to the network 108, it is also expressly contemplated that the database 110 may be hosted on the computer system 102. The database 110 allows the computer system 102 to store and retrieve data.

FIG. 2 is a flowchart of a computer-implemented method 200 for calculating counterparty risk in accordance with an embodiment of the present invention. Specifically, method 200 may be executed by a risk calculation application that is executed by a processor of computer system 102 as described above with reference to FIG. 1. Similar to what is described above, the computer system 102 is coupled to a communications network 108. Also coupled to the communications network, or hosted on the computer system 102, is a database 110, as described above. Illustratively, the risk calculation application is implemented in Python using PyTorch. PyTorch is publicly available at pytorch.org and is widely used in the data science field. The PyTorch code is hardware-agnostic and can be executed on various computer system architectures or hardware architectures, such as traditional central processing units (CPUs), graphics processing units (GPUs), tensor processing units (TPUs), neural processing units (NPUs) and combinations thereof. The code can be executed on any of these hardware architectures without modifications and is therefore highly portable. Executing the risk calculation application on a CPU-based architecture is serialized and therefore already efficient. It uses all available threads of the CPU and is executed in a vectorized manner. Executing the risk calculation application on a GPU-based, TPU-based, and/or NPU-based architecture leverages the multiple processing units available and accelerates the method more than 250 times. The method then runs truly parallelly and scales up to the memory limit of the corresponding hardware architecture with limited impact on run time. Even when using a large number of market scenarios, such as 10,000,000, the entire method is executed within 0.004 seconds.

In addition to calculating counterparty risk in parallel instead of sequentially, the method 200 is also more memory-efficient than traditional methods. Current counterparty risk calculation involves calculating changes in market value for each transaction, and then aggregating to the portfolio level to calculate an average and 95% quantile. The method 200 described herein calculates an average market scenario and a high-risk market scenario, exemplarily at the 95% quantile, and then multiplies these scenarios by the beta-adjusted portfolio value to determine the average and potential/high-risk portfolio exposure. This is equivalent to the traditional method but more memory efficient. In addition, the method 200 only saves two output values, and optionally a random seed, to the database 110 and thereby removes the need to save intermediate data. Saving data from memory to a database is time-consuming and therefore responsible for longer processing times.

In step 210, the risk calculation application executing on computer system 102 receives a plurality of transactions in a portfolio. Each of the transactions includes a market value and a beta value. As an example, there are N transactions in the portfolio, and calculation of the counterparty risk of the portfolio is desired. Each transaction is associated with one security and includes an identification of the security, a market value of the transaction x, and a beta value B. The beta value indicates the security's sensitivity to the market, is usually measured against the broad market, and may be obtained through a data provider or may be calculated in any way known to the skilled person. The plurality of transactions and its associated market and beta values is stored in memory. Depending on where the risk calculation application is executing, this may be the memory 106 of processor 104, or it may be the memory of the GPU/TPU/NPU 112.

In step 220, the risk calculation application executing on computer system 102 generates a plurality of market scenarios based on a log normal distribution. The computer system 102 generates the plurality of market scenarios in parallel. As described above, parallel processing may be achieved by the processor 104 having more than one core, by providing a plurality of processors configured to execute the risk calculation application, and by a combination thereof. The market scenarios are modeled by a log-normal distribution with mean μ and standard deviation σ, Lognormal (μ, σ\hat{ }2). The mean and standard deviation of the log-normal distribution may be obtained through a data provider or may be calculated in any way known to the skilled person. As an example, the risk calculation application generates 10,000 market scenarios based on a log-normal distribution that the market is assumed to follow. In other words, the risk calculation application executing on processor 102 draws 10,000 samples from the log-normal distribution Lognormal (μ, σ\hat{2}). The 10,000 samples may be selected in any suitable way known to the skilled person. For example, the 10,000 samples may be selected using a random number generator. The random number generator is initialized with a random seed and configured to always output the same sequence of random numbers for a certain random seed. In other words, a certain output sequence of the random number generator is reproducible by initializing the random number generator with the same random seed. In some embodiments, the risk calculation application may store the random seed in database 110 to allow for reproducing the counterparty risk calculation at a later time. The risk calculation application may, for example, use the first 10,000 numbers from the output of the random numbers generator to select 10,000 samples from the log-normal distribution. Illustratively, the sampled values, and thereby the generated market scenarios, are as follows:

| Scenario | Market Scenario |
|---|---|
| 1 | 0.03718 |
| 2 | 0.00029 |
| 3 | 0.02059 |
| . . . | |
| 10,000 | −0.0137 |

In some embodiments, the risk calculation application may filter the selected market scenarios to only include positive market scenarios. In the example above, scenario 10,000 may be excluded from the sample set because it is negative. The risk calculation application may then select more samples from the log-normal distribution to replace the filtered scenarios and may repeat this step until 10,000 positive scenarios have been selected. Alternatively, the risk calculation application may filter the market scenarios to only include positive market scenarios and not replace the filtered scenarios. In that case, the plurality of market scenarios may have less members than originally selected.

The filtering of the market scenarios is performed in parallel by the risk calculation application. By way of example, the parallelization provided by PyTorch is described here for the filtering of the market scenarios. For each one of the 10,000 market scenarios, the risk calculation application determines whether the market scenario is greater than or equal to 0, or if it is less than zero. In other words, the list of market scenarios is filtered as follows:

market_scenarios=market_scenarios[market_scenarios>=0]

In the prior art, filtering is performed on a CPU without using vectorization, i.e. on a scalar processor. In other words, one market scenario is filtered at a time. The risk calculation application described herein improves the filtering on a CPU by using a single instruction multiple data (SIMD) approach. The step of filtering the market scenarios is vectorized through PyTorch so that four scenarios are filtered at a time. To this end, the list of market scenarios is converted to vectors of size 4, each vector therefore including 4 market scenarios. Each of these vectors is then processed by the CPU sequentially. This approach provides a 4-times speedup compared to execution without vectorization. It is noted that the vector size may be different than 4 and may be selected according to the capabilities of the CPU used and/or the needs of the user. If more than one CPU is being used and/or if the CPU has more than one processing core, the execution time is improved even more. For example, in a CPU that has 4 cores, each one of the cores filters one vector at a time. Thus, 4 vectors including 16 market scenarios can be processed at the same time. The speedup compared to execution without vectorization is therefore 16.

If the risk calculation application performs the filtering of the market scenarios on a GPU, even larger vector sizes may be used. GPUs typically have a large number of processing cores, of which each one may perform the filtering operation. Illustratively, an A100 GPU (Nvidia Corporation, Santa Clara, CA) has 6,912 cores, thus providing 6,912 arithmetic logic units (ALUs). For this GPU, the filtering of the market scenarios is vectorized through PyTorch so that 6,912 scenarios are filtered in parallel at the same time. The list of market scenarios is converted to vectors of size 6,912 (or smaller if less than 6,912 market scenarios are left to be filtered). Each one of these vectors is then processed by the GPU sequentially. If the risk calculation application performs the filtering of the market scenarios on a TPU or NPU, the list of market scenarios may be converted to a matrix. A TPU and/or NPU includes a matrix multiplication unit that may, for example, provide 65,536 ALUs to process matrices of size 256×256. For this illustrative TPU, the filtering of the market scenarios is performed in matrix form by PyTorch so that 65,536 scenarios are filtered in parallel at the same time. The list of market scenarios is converted to matrices of size 256×256 (or smaller, if less than 65,536 market scenarios are left to be filtered). Each of these matrices is then processed by the TPU and/or NPU sequentially. While separate CPU, GPU, and TPU/NPU examples are described, it is expressly noted that the computer system 102 may include more than one type of processor and that the risk calculation application performs the filtering of the market scenarios in parallel on more than one type of processor. For example, the risk calculation application may utilize a GPU and multi-core CPU included in computer system 102 to filter 6,912 market scenarios on the GPU and 16 market scenarios on the CPU, resulting in 6,928 market scenarios being filtered in parallel at the same time. The use of PyTorch allows for a simple and easy adaptation of the risk calculation application to a new hardware configuration, because PyTorch supports CPUs, GPUs, and/or TPUs/NPUs via integrated compilers. A risk calculation application executing on CPU may therefore be simply recompiled to be executed on a GPU TPU/NPU, or any combination of processor architectures.

While the example given here includes 10,000 market scenarios, it is also expressly contemplated that the plurality of market scenarios includes less or more members. Given that the risk calculation application is executed in parallel, the plurality of market scenarios may include 10,000,000 market scenarios or more. The risk calculation application may generate and filter the plurality of market scenarios fully in memory 106 without relying on external memory or disk-based storage. Performing these tasks in memory 106 ensures that the risk calculation application generates and filters the plurality of market scenarios quickly and efficiently.

In step 230, the risk calculation application executing on computer system 102 calculates an average market scenario and a high-risk market scenario. These two scenarios are calculated in parallel and based on the plurality of market scenarios generated in step 220. The average market scenario, for example, may be a mean of all values of the market scenarios. The high-risk market scenario may be a 95% quantile of all values of the market scenarios. In other embodiments, the high-risk market scenario may be a different quantile than 95%. For example, the high-risk market scenario may be a 90% quantile or a 98% quantile of all values of the market scenarios, or any other quantile suitable to perform counterparty risk calculation. The risk calculation application may calculate the average market scenario and the high-risk market scenario fully in memory 106 from the plurality of market scenarios that is already stored in memory 106. After calculating the average market scenario and the high-risk market scenario, the risk calculation application may free up parts of memory 106 by deleting the stored market scenarios.

In step 240, the risk calculation application executing on computer system 102 calculates a beta-adjusted portfolio value based on the plurality of market values and plurality of beta values of the plurality of transactions. The beta-adjusted portfolio value is calculated in parallel and may also be calculated fully in memory 106. The beta-adjusted portfolio value is the sum of beta-adjusted values of each transaction in the plurality of transactions. Illustratively, the plurality of transactions in the portfolio may include the following three transactions:

| Symbol | Market Value (x) | Beta β |
|---|---|---|
| ABC | $25,139.72 | 1.57 |
| DEF | $3,709.58 | 0.98 |
| GHI | $976.50 | 1.34 |

In this example, the beta-adjusted value of ABC is the market value of ABC multiplied by the beta value of ABC, i.e., $39,649.36. The beta-adjusted value of DEF is the market value of DEF multiplied by the beta value of DEF, i.e. $3,635.39. The bete-adjusted value of GHI is the market value of GHI multiplied by the beta value of GHI, i.e. $1,308.51. The beta-adjusted portfolio value now is the sum of the beta-adjusted values of the transactions in the portfolio. In the example above, the beta-adjusted portfolio value is $44,593.26.

In step 250, the risk calculation application executing on computer system 102 calculates an expected portfolio exposure based on the beta-adjusted portfolio value calculated in step 240 and the average market scenario calculated in step 230. The expected portfolio exposure is a measure of average counterparty risk and may be calculated by multiplying the average market scenario with the beta-adjusted portfolio value.

In step 260, the risk calculation application executing on computer system 102 calculates a potential portfolio exposure based on the beta-adjusted portfolio value calculated in step 240 and the high-risk market scenario calculated in step 230. The potential portfolio exposure is a measure of worst-case counterparty risk and may be calculated by multiplying the high-risk market scenario with the beta-adjusted portfolio value.

In step 270, the risk calculation application executing on computer system 102 stores the expected portfolio exposure calculated in step 250 and the potential portfolio exposure calculated in step 260 in a database, such as database 110. As stated above, the risk calculation application may also store the seed of the random number generator in database 110 to allow for reproducibility of the calculations.

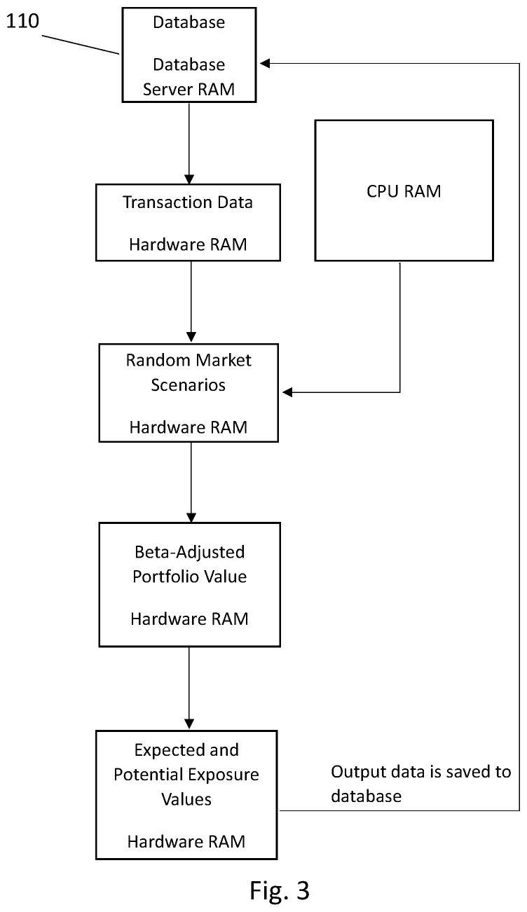

FIG. 3 is a memory chart for a method for calculating counterparty risk in accordance with an embodiment of the present invention. As can be seen in FIG. 3, the process 200 described above mostly uses device, or hardware, RAM, such as GPU memory, TPU memory, and/or NPU memory. Therefore, the process avoids frequent interactions between CPU memory, GPU/TPU/NPU memory, and local storage which avoids time-consuming transfers of data. In addition, the method described herein eliminates interaction with the database 110, except at the input and output stages. While financial regulations typically require all intermediate data to be saved and results to be reproducible, the method 200 satisfies these regulations by using and saving a random seed, as described above with reference to step 220. Having a saved random seed renders the results of the counterparty risk calculation reproducible on any platform by setting the same random seed. In addition, any other intermediate result also may be saved if necessary.

As shown in FIG. 3, the transaction data is retrieved from the database 110 and stored in hardware RAM. Depending on where the risk calculation application is executed, this may be the main memory 106 of the computing device 102, or it may be a memory of GPU, TPU and/or NPU 112. The random market scenarios are also generated in hardware RAM. If a random seed is used, the random seed may be provided by the processor 104 from memory 106. In other embodiments, the random seed may be retrieved by the processor 104 from the database 110 and then provided to the risk calculation application. As described above, the plurality of market scenarios may be deleted from the hardware RAM after calculating the average and high-risk market scenarios to save memory space. The beta-adjusted portfolio value is also calculated using the data available in the hardware RAM and stored in the hardware RAM. Finally, the expected and potential exposure values are calculated from data available in the hardware RAM and stored in the hardware RAM. These two values may then be saved to the database 110.

Embodiments of the present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, networker, or locator.) Source code may include a series of computer program instructions implemented in any of various programming languages (e.g., an object code, an assembly language, or a high-level language such as Fortran, C, C++, Python, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies, networking technologies, and internetworking technologies. The computer program may be distributed in any form as a removable storage medium with accompanying printed or electronic documentation (e.g., shrink wrapped software or a magnetic tape), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

The foregoing description described certain example embodiments. It will be apparent, however, that other variations and modifications may be made to the described embodiments, with the attainment of some or all of their advantages. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A computer-implemented method for calculating counterparty risk using a risk calculation application executing on a computer system, the method comprising:
receiving, by the risk calculation application, a plurality of transactions in a portfolio, each one of the transactions including a market value and a beta value;
generating, by the risk calculation application and in parallel, a plurality of market scenarios based on a log-normal distribution;
calculating, by the risk calculation application and in parallel, an average market scenario and a high-risk market scenario based on the plurality of market scenarios;
calculating, by the risk calculation application and in parallel, a beta-adjusted portfolio value based on the plurality of market values and the plurality of beta values;
calculating, by the risk calculation application, an expected portfolio exposure based on the beta-adjusted portfolio value and the average market scenario;
calculating, by the risk calculation application, a potential portfolio exposure based on the beta-adjusted portfolio value and the high-risk market scenario; and
storing, by the risk calculation application, the expected portfolio exposure and the potential portfolio exposure in a database.

2. The computer-implemented method of claim 1, wherein the risk calculation application is portable between a plurality of computer system architectures.

3. The computer-implemented method of claim 2, wherein the plurality of computer system architectures includes a central processing unit-based architecture, a graphical processing unit-based architecture, and a tensor processing unit-based architecture.

4. The computer-implemented method of claim 1, wherein the plurality of market scenarios is generated using an output of a random number generator to determine samples from the log-normal distribution.

5. The computer-implemented method of claim 4, wherein the random number generator is initialized with a random seed.

6. The computer-implemented method of claim 5, further comprising storing, by the risk calculation application, the random seed in the database.

7. The computer-implemented method of claim 1, further comprising filtering, by the risk calculation application and in parallel, the plurality of market scenarios to only include positive market scenarios.

8. The computer-implemented method of claim 1, wherein the plurality of market scenarios includes at least 10,000,000 market scenarios.

9. The computer-implemented method of claim 1, wherein the risk calculation application generates the plurality of market scenarios and performs all calculations in a memory of the computer system.

10. A system for calculating counterparty risk, the system comprising:
a computer system having a processor coupled to a memory, the processor configured to execute a risk calculation application, the risk calculation application configured to:
receive a plurality of transactions in a portfolio, each one of the transactions including a market value and a beta value;
generate, in parallel, a plurality of market scenarios based on a log-normal distribution;
calculate, in parallel, an average market scenario and a high-risk market scenario based on the plurality of market scenarios;
calculate, in parallel, a beta-adjusted portfolio value based on the plurality of market values and the plurality of beta values;
calculate an expected portfolio exposure based on the beta-adjusted portfolio value and the average market scenario;
calculate a potential portfolio exposure based on the beta-adjusted portfolio value and the high-risk market scenario; and
store the expected portfolio exposure and the potential portfolio exposure in a database.

11. The system of claim 10, wherein the risk calculation application is portable between a plurality of computer system architectures.

12. The system of claim 11, wherein the plurality of computer system architectures includes a central processing unit-based architecture, a graphical processing unit-based architecture, and a tensor processing unit-based architecture.

13. The system of claim 10, wherein the plurality of market scenarios is generated using an output of a random number generator to determine samples from the log-normal distribution.

14. The system of claim 13, wherein the random number generator is initialized with a random seed such that the same plurality of market scenarios is sampled using the same random seed.

15. The system of claim 14, wherein the risk calculation application is further configured to store the random seed in the database.

16. The system of claim 10, wherein the risk calculation application is further configured to filter, in parallel, the plurality of market scenarios to only include positive market scenarios.

17. The system of claim 10, wherein the plurality of market scenarios includes at least 10,000,000 market scenarios.

18. The system of claim 10, wherein the risk calculation application generates the plurality of market scenarios and performs all calculations in the memory.

19. A non-transitory computer-readable medium having software encoded thereon, the software, when executed by one or more computer systems operable to:
receive a plurality of transactions in a portfolio, each one of the transactions including a market value and a beta value;
generate, in parallel, a plurality of market scenarios based on a log-normal distribution;
calculate, in parallel, an average market scenario and a high-risk market scenario based on the plurality of market scenarios;
calculate, in parallel, a beta-adjusted portfolio value based on the plurality of market values and the plurality of beta values;
calculate an expected portfolio exposure based on the beta-adjusted portfolio value and the average market scenario;
calculate a potential portfolio exposure based on the beta-adjusted portfolio value and the high-risk market scenario; and
store the expected portfolio exposure and the potential portfolio exposure in a database.

20. The non-transitory computer-readable medium of claim 19, wherein the software is portable between a plurality of computer system architectures including a central processing unit-based architecture, a graphical processing unit-based architecture, and a tensor processing unit-based architecture.
